(19) United States
(12) Patent Application Publication
(10) Pub. No.: US 2014/0378016 A1
(43) Pub. Date: Dec. 25, 2014

(54) MAGNETICALLY MODIFIED METALS AND METAL ALLOYS FOR HYDRIDE STORAGE

(71) Applicant: UNIVERSITY OF IOWA RESEARCH FOUNDATION, Iowa City, IA (US)

(72) Inventors: Johna Leddy, Iowa City, IA (US); Jessica Jewett Reed, Des Moines, IA (US)

(21) Appl. No.: 14/383,047

(22) PCT Filed: Mar. 15, 2013
(86) PCT No.: PCT/US2013/032666

§ 371 Date: Sep. 4, 2014

Related U.S. Application Data
(60) Provisional application No. 61/617,508, filed on Mar. 29, 2012.

(51) Int. Cl. C01B 3/00; C22C 5/04; C01G 49/08; H01F 1/01; H01M 4/86; H01M 4/24

(52) U.S. Cl. CPC C01B 3/0078; H01M 4/86; H01M 4/242; C01G 49/08; H01F 1/01; C22C 5/04; C01P 2006/42
USPC 442/1; 428/693.1; 205/637; 423/632; 252/62.56; 423/648.1; 423/658.2; 420/463; 420/591

(57) ABSTRACT

A device comprising a magnetic element, which comprises a magnetic material, wherein the magnetic element is adapted to absorb hydrogen to form hydride. The magnetic aspect of the system enhances the hydrogen storage. Also disclosed is a metal hydride element comprising a magnetic material and absorbed hydrogen. The magnetic element and the metal hydride element can be an electrode. Further disclosed are methods for making and using the electrode.

### RELATED APPLICATIONS

This application claims priority to U.S. provisional application 61/617,508 filed Mar. 29, 2012, which is incorporated herein by reference in its entirety.

### FEDERAL FUNDING STATEMENT

This invention was made with government support under Contract No. NSF0809745 awarded by the United States National Science Foundation. The Government has certain rights in the invention

### BACKGROUND

Today efforts are being made by governments and researchers to transition away from an economy dependent on fossil fuels to alternative energies. Not only are alternative fuel sources necessary to relieve the burden of dwindling oil supplies, they are an answer to environmental sustainability woes. While hydrogen is still being explored as a commercial fuel, it is an attractive energy source for many reasons. Its natural abundance and straight forward synthesis make it a viable alternative to fossil fuels energy sources. In addition, hydrogen can be stored for a long time without significant degradation, unlike stored electrical charge. In principle, hydrogen fueled vehicles could emit only water from their exhaust systems. However, until better and efficient storage systems are created the use of hydrogen as a fuel is a concern of safety.

There are three types of hydrogen storage: gaseous, liquid, and solid state. A major drawback of gaseous and liquid storage is the relatively small amount of hydrogen that may be stored, even under high pressure. The sheer volume of hydrogen needed to give comparable energy density to gasoline is more than can currently be feasibly stored onboard a vehicle (Sandi, Interface 2004, 40-43). Solid state storage refers to the storage of hydrogen in metal hydrides and other nanostructured materials.

Metal hydrides form when hydrogen reacts with a metal or alloy to create a new hydrogen containing product. The reaction can be seen in Equation 1 where M represents the metal and H the hydrogen.

xM+(y/2)H₂=MxHy (1)

Metal hydrides show promise for solid state storage of hydrogen due to their ability to store large amounts of hydrogen in small volumes and their relative stability. Since metal hydrides are typically solids at ambient conditions, they are less volatile than compressed gas or liquid hydrogen, which is an important factor to consider for fuel containment in the event of a crash.

While this type of solid state storage is likely to be most suitable to meet the specifications for onboard vehicle hydrogen fuel storage, it suffers an energetic cost associated with electrochemically driving the hydrogen into and out of the storage material lattice. In addition to energetic costs, the absorption and release of hydrogen in the metal are kinetically rate limited at atmospheric pressure. This means that the release of the hydrogen fuel from the storage material is not rapid enough to meet consumer demands. The rate is so slow because of the energy tax associated with the interfacial kinetics for hydrogen atom transfer. The slow kinetics are manifest as a large energetic cost so that the value of hydrogen as a fuel is markedly diminished. Poor interfacial hydrogen atom transfer is an obstacle to hydrogen as a viable fuel source especially in portable applications.

Accordingly, there remains an unmet need in the art for improved hydride absorption in order to decrease the energetic cost of metal hydride formation, to increase the kinetics of the reaction, and to provide better solid state hydrogen storage devices. The energetic taxes are extracted for both hydrogen adsorption and hydrogen desorption. A process that overcomes the poor kinetics of both adsorption and desorption is particularly valuable.

### SUMMARY

Embodiments described herein include articles, devices, and compositions, as well as methods of making and methods of using same.

Described here, for example, is a device comprising a magnetic element, which comprises a magnetic material, wherein the magnetic element is adapted to absorb hydrogen to form hydride.

In one embodiment, the magnetic element comprises a hydrogen-absorbing material different from the magnetic material.

In one embodiment, the magnetic material is a hydrogen-absorbing material.

In one embodiment, the magnetic element comprises a substrate and a coating disposed on the substrate, wherein: (i) the substrate comprises a hydrogen-absorbing material different from the magnetic material, and wherein the coating comprises the magnetic material, or (ii) the substrate comprises the magnetic material, and wherein the coating comprises a hydrogen-absorbing material different from the magnetic material.

In one embodiment, the magnetic element comprises a mixture of the magnetic material and a hydrogen-absorbing material different from the magnetic material.

In one embodiment, the magnetic element comprises metal.

In one embodiment, the magnetic element comprises Pd or an alloy thereof.

In one embodiment, the magnetic element comprises an AB₂ or AB_{S} material.

In one embodiment, the magnetic material comprises Fe₃O₄, Fe₂O₃, NdFeB, SmOCo₅, Sm₂Co₁₇, Sm₂Co₇, La_{0.9}Sm_{0.1}Ni₂Co₃, Ti_{0.51}Zr_{0.49}V_{0.70}Ni_{1.18}Cr_{0.12}, or a combination thereof.

In one embodiment, the magnetic material comprises Fe₃O₄, NdFeB, SmCo₅, or a combination thereof.

In one embodiment, the magnetic material comprises at least one magnetic particle, magnetic wire, or magnetic mesh.

In one embodiment, the magnetic material comprises at least one magnetic particle comprising a magnetic core and a protective coating.

In one embodiment, the magnetic material comprises at least one magnetic particle comprising a magnetic core and a silane protective coating.

In one embodiment, the magnetic material comprises at least one magnetic particle comprising a Fe₃O₄ magnetic core and a —Si—CH₃ protective coating.

In one embodiment, the magnetic material is not externally magnetized.

In one embodiment, the magnetic material is externally magnetized.

In one embodiment wherein the magnetic element comprises a substrate and a magnetic coating, the magnetic coating further comprises at least one polymer.

In one embodiment wherein the magnetic element comprises a substrate and a magnetic coating, the magnetic coating further comprises at least one ion exchange polymer or at least one conducting polymer.

In one embodiment wherein the magnetic element comprises a substrate and a magnetic coating, the magnetic coating further comprises at least one Nafion polymer or derivative thereof.

In one embodiment wherein the magnetic element comprises a substrate and a magnetic coating, the magnetic coating further comprises octadecyltrimethylammonium bromide Nafion or an alkyl ammonium modified Nafion.

In one embodiment, the magnetic element comprises metal, and wherein the presence of the magnetic material decreases the potential or energy tax/cost for electrochemically absorbing hydrogen to form metal hydride.

In one embodiment, the magnetic material increases the absorption rate of hydrogen into the magnetic element by at least 10%, or wherein the magnetic material increases the desorption rate of hydrogen into the magnetic element by at least 10%.

In one embodiment, the magnetic element is an electrode.

In one embodiment, the magnetic element comprises metal hydride.

In one embodiment, the device is a fuel cell.

Also described here is a metal hydride element comprising a magnetic material.

In one embodiment, the metal hydride element comprises a substrate and a coating disposed on the substrate, wherein: (i) the substrate comprises a metal hydride different from the magnetic material, and wherein the coating comprises the magnetic material, or (ii) the substrate comprises the magnetic material, and wherein the coating comprises a metal hydride different from the magnetic material.

In one embodiment, the metal hydride element comprises a mixture of the magnetic material and a metal hydride different from the magnetic material.

In one embodiment, the magnetic material is a metal hydride.

In one embodiment, the metal hydride element comprises Pd, an alloy thereof, or an AB₂ or AB_{S} material.

In one embodiment, the magnetic material comprises at least one magnetic particle, magnetic wire, or magnetic mesh.

In one embodiment, the magnetic material comprises Fe₃O₄, Fe₂O₃, NdFeB, SmCo₅, Sm₂Co₁₇, Sm₂Co₇, La_{0.9}Sm_{0.1}Ni₂Co₃, Ti_{0.51}Zr_{0.49}V_{0.70}Ni_{1.18}Cr_{0.12}, or a combination thereof.

In one embodiment, the presence of the magnetic material decreases the potential for electrochemically absorbing hydrogen to form metal hydride.

In one embodiment, the metal hydride element is substantially free of any metal hydroxide.

Also described here is a fuel cell device comprising the metal hydride element as electrode.

Also described here is a nickel metal hydride battery comprising the metal hydride element of as electrode.

Further described here is a method for making the metal hydride element, comprising (i) contacting a magnetically-modified element with a hydrogen source, wherein the magnetically-modified element comprises a metal-based hydrogen-absorbing material and a magnetic material; and (ii) applying an electrochemical potential to form a metal hydride element.

Further described here is a method for making the metal hydride element, comprising contacting a magnetically-modified element with a pressurized hydrogen gas, wherein the magnetically-modified element comprises a metal-based hydrogen-absorbing material and a magnetic material.

Additionally described here is a method for using the device comprising the magnetic element described above, comprising absorbing hydrogen into the magnetic element, and optionally desorbing hydrogen therefrom. In one embodiment, the method further comprises demagnetizing the magnetic material to reduce desorption of the absorbed hydrogen.

Additionally described here is a method for using the metal hydride element described above, comprising desorbing hydrogen from the metal hydride element, and optionally resorbing hydrogen to form metal hydride. In one embodiment, the method further comprises using the desorbed hydrogen to generate energy.

### BRIEF DESCRIPTION OF THE DRAWINGS

FIG. 1 depicts hydrogen absorption in palladium. The hydrogen atoms occupy octahedral (Oₕ) and tetrahedral (T_{d}) sites in the palladium lattice.

FIG. 2 shows cyclic voltammograms at a Pd electrode in 0.5 M H₂SO₄ at 298K. Scan rate is 50 mV/s. The upper potential limit is fixed at 1.40 V while the lower limit is decreased to either ˜0.22 or ˜0.25 V to show H absorption into Pd.

FIG. 3 shows the voltammetric profile for an unmodified Pd electrode versus SCE in 0.1M HNO₃. The electrode area is the same in all figures, Area=0.438 cm². Scan rate is 50 mV/s.

FIG. 4 shows the comparison of voltammetric data for electrodes modified with a Nafion film and for a composite of Nafion and Bangs magnetic microparticles in 0.1M HNO₃ at scan rate of 50 mV/s. The film was dried in an external magnetic field. Nafion film (gray, long-short dash) and composite (black, short dash) are shown. The voltammetric wave for the magnetically modified electrode is characteristic of faster kinetics than the simple Nafion film as shown by (e.g., 2 mA) for smaller voltage perturbations from approximately ˜0.1V on reduction and oxidation.

FIG. 5 shows an overlay of cyclic voltammograms from composite films of TMODA-Nafion and SiMAG particles. The electrolyte is 1.0 mM HNO₃ and scan rate is 50 mV/s. C1(black, solid), C3 (pink, solid), C8 (blue, long dash), C18 (green, short dash).

FIG. 6 shows an overlay comparing cyclic voltammograms for a blank TMODA-Nafion film, and composites of TMODA-Nafion with C1 or glass microbeads. The electrolyte is 1.0 mM HNO₃ and scan rate is 50 mV/s. Blank (blue, solid), C1 (pink, short dash), Glass microbeads (black, long dash).

FIG. 7 shows an overlay of cyclic voltammograms comparing blank TMODA-Nafion to composites containing C1 microparticles. The magnetized C1 particles had been exposed to an external magnet for magnetic field alignment. The supporting electrolyte is 0.1M HNO₃ and scan rate is 50 mV/s. Blank (black, solid), Non-magnetized C1 (pink, solid), Magnetized C1 (blue, short dash). Both composites that contain C1 magnets yield higher current than the TMODA-Nafion film. The microstructure on magnetization will differ from the composite formed with magnetic particles that is not magnetized during formation of the composite on the electorate.

FIG. 8 shows an overlay of cyclic voltammogram data for TMODA-Nafion film and composite films of TMODA and C1 particles at pH values of 5 and 10. The electrolyte was 0.1M NaNO₃ and the scan rate was 50 mV/s. TMODA-Nafion film at pH 10 (black, solid), TMODA-Nafion film at pH 5 (gray, long dash), C1 composite at pH 5 (pink, short dash), C1 composite at pH 10 (green, long dash-short dash).

FIG. 9 shows one exemplary embodiment of the magnetic element described herein wherein the magnetic material is present in a coating.

FIG. 10 shows one exemplary embodiment of the magnetic element described herein wherein the magnetic material is mixed with the hydrogen absorbing material.

### DETAILED DESCRIPTION

### Introduction

All references described herein are hereby incorporated by reference in their entireties.

Though magnetic modification of electrodes was previously shown to increase rates of electron transfer in the positive electrode of batteries (see U.S. Pat. No. 8,231,988, incorporated herein by reference in its entirety), its impact on atom transfer is unknown in the art. For example, in hydrides storage, proton (H⁺) is first converted to hydrogen atom (H.), which then cross the electrode interface to absorb into the electrode. This process allows storage of hydrogen as hydrogen radical also called hydrogen atom in the electrode as a hydride or metal hydride. More hydrogen can be stored as the hydride in palladium than as compressed hydrogen gas. The challenge of metal hydride storage is that the kinetics of getting the hydrogen in and out of the electrode is slow and therefore also energy intensive. As described herein, magnetic modification of electrodes significantly improves the rates of atom transfer and hydride storage. Such electrodes are particularly useful in fuel cells and Ni-MH batteries.

In an alternative embodiment, hydrogen storage in a material can be facilitated with magnetic modification where the material is not serving as an electrode. In the electrode configuration, the magnetically modified electrode can serve for hydrogen generation and storage where the electrode generates hydrogen in the electrolysis that contains hydrogen donors and stores the generated hydrogen as hydride in the electrode.

Magnetic materials are described in, for example, U.S. Pat. No. 8,231,988, U.S. Pat. No. 7,709,115 and U.S. Pat. No. 6,890,670, all of which are incorporated herein by reference in their entireties.

Fuel cells are described in, for example, US 2010/0021776; US 2010/0159365; US 3853628, and JP 2002198057, all of which are incorporated herein by reference in their entireties.

Ni-MH batteries are described in, for example, U.S. Pat. No. 7,709,115 and U.S. Pat. No. 6,890,670, both of which are incorporated herein by reference in their entireties.

### Magnetic Element for Hydrogen-Storage Device

Many embodiments described herein relates to a device, such as a hydrogen-storage device, comprising a magnetic element. The magnetic element can comprise, for example, at least one magnetic material, wherein the magnetic element is adapted to absorb hydrogen via the formation of hydride.

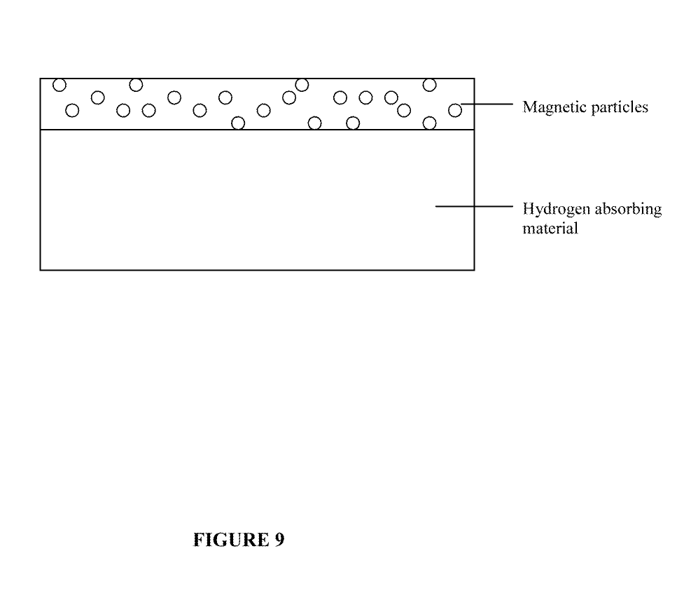

The magnetic element can comprise, for example, a substrate and a coating disposed on the substrate, wherein the substrate comprises a hydrogen-absorbing material different from the magnetic material, and wherein the coating comprises the magnetic material, as shown in FIG. 9.

The magnetic element can comprise, for example, a substrate and a coating disposed on the substrate, wherein the substrate comprises the magnetic material, and wherein the coating comprises a hydrogen-absorbing material different from the magnetic material.

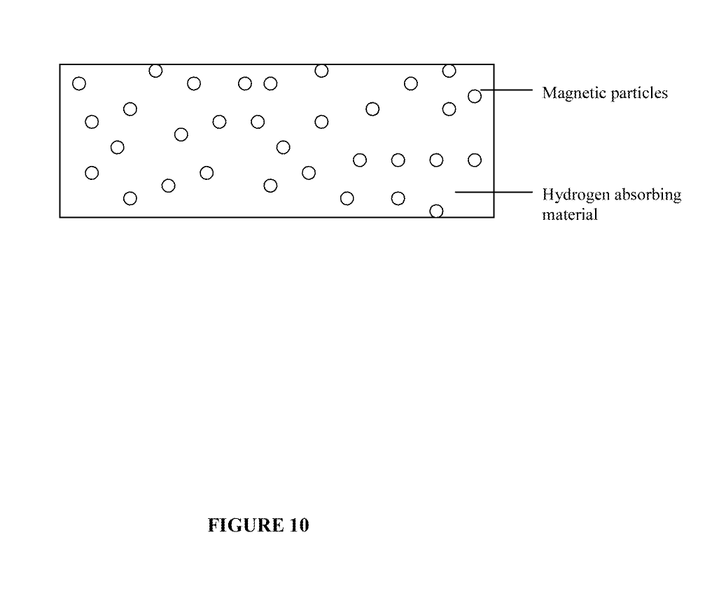

The magnetic element can comprise, for example, a mixture of the magnetic material and a hydrogen-absorbing material different from the magnetic material, as shown in FIG. 10. The mixture can be formed by, for example, melting the hydrogen-absorbing material and adding the magnetic material having a higher melting point. In other words, the magnetic material can be inserted into the bulk of the hydrogen-absorbing material rather than merely coated on its surface. When the matrix is formed by heating, it will be necessary to determine whether or not the magnetic component has been heated above a temperature (e.g., Curie temperature) so that the magnetic particles are demagnetized. If the magnetic particles are demagnetized on formation, it is necessary to re-magnetized the particles after the temperature has been lowered to allow solidification of the composite. Magnet incorporated conducting electrodes were formed previously where magnetic microparticles are disbursed in an electron conducting matrix of carbon particles. In a heterogeneous matrix composed of at least two components where one is the hydrogen absorbing media (e.g., palladium) and the other is a magnetic component, intimately mixed, the requirements for magnetic impact on hydrogen absorption are satisfied. A third component might provide enhanced electron conduction in such a matrix should be hydride forming component also serve as an electrode. The third component might be for example a carbon particulate.

The magnetic element can comprise, for example, a metal or an alloy that is magnetic. In other words, the hydrogen-absorbing material itself can be rendered magnetic. For example, palladium is paramagnetic, which means it can support a magnetic field under externally applied field. But once the action field is removed, the magnetization of the palladium will dissipate. Materials that are ferrimagnetic or ferromagnetic or anti-ferromagnetic will support permanent magnetic field if they are of sufficient size. Some hydride forming materials such as AB5 and AB2, which are ferrimagnetic or ferromagnetic, may be able to support a permanent magnetic field.

The presence of the magnetic material in or near the magnetic element can, for example, decreases the potential for electrochemically absorbing hydrogen to form a metal hydride. The presence of the magnetic material in or near the magnetic element can, for example, decrease the energetic cost of metal hydride formation and increase the kinetics of the reaction.

Alternatively, the magnetic element can be described in its hydride state. For example, the magnetic element can be a metal hydride element comprising at least one magnetic material and at least one metal hydride, wherein the magnetic material can be different from or the same as the metal hydride. The presence of the magnetic material in the magnetic element can, for example, accelerate atom transfer. In one embodiment, the magnetic element is substantially free of any metal hydroxide such as nickel hydroxide.

A further alternative embodiment is where the hydride forming material is magnetically modified but the hydride is not part of an electrochemical circuit. In these embodiments, the hydride is loaded and released by changes in the external pressure of, for example, hydrogen gas at the surface of the hydride forming material that is magnetically modified. Magnetic modification can include either incorporation of magnetic materials as described in FIGS. 9 and 10 or magnetizing the metal hydride forming material that is either paramagnetic, ferrimagnetic or ferromagnetic.

The above embodiments apply to both adsorption of hydride and desorption of hydrogen radical. Both the processes of absorption and desorption are accelerated by the magnetic modification described herein. The acceleration in the kinetics corresponds to a decrease in the overall energetic tax to drive storage of hydrogen as hydride and release of hydrogen as hydrogen radical.

### Hydrogen-Absorbing Material

Hydrogen-absorbing materials suitable for the hydride storage device described herein include materials known in the art. The hydrogen-absorbing material can comprise, for example, a metal or an alloy thereof.

The hydrogen-absorbing material can comprise, for example, a transition metal. The hydrogen-absorbing material can comprise, for example, palladium. The hydrogen-absorbing material can comprise, for example, a palladium alloy such as silver or copper-modified palladium, or a palladium-modified lighter metal material. The hydrogen-absorbing material can comprise, for example, an alkaline earth metal such as Ca or Mg, or an alkali metal such as Na or Li. The hydrogen-absorbing material can comprise, for example, complex metals comprising sodium, lithium, or calcium. The hydrogen-absorbing material can comprise, for example, AB₅ or AB₂ materials common in nickel metal hydride batteries and other metal hydride batteries. In a preferred embodiment, the hydrogen-absorbing material comprises palladium.

Alternatively, the hydrogen-absorbing material can be described in its hydride state. The hydrogen-absorbing material can comprise one or more compounds selected from, for example, palladium hydride, MgH₂, NaAlH₄, LiAlH₄, LiH, LaNi₅H₆, Mg₂NiH₄, TiFeH₂, LiNH₂, LiBH₄ and NaBH₄, as well as the hydrides of AB5 and AB2 material.

### Magnetic Material

Magnetic materials described herein are known in the art and include, for example, materials that develop a magnetic moment following exposure to a strong magnetic field for a sufficient period of time (See U.S. Pat. Nos. 8,231,988, 7,709,115 and 6890670). The magnetic material can comprise, for example, permanent magnetic materials, paramagnetic materials, superparamagnetic materials, ferromagnetic materials, ferrimagnetic materials, superconducting materials, anti-ferromagnetic materials, and combinations thereof.

In one embodiment, the magnetic material comprises at least one permanent magnetic material selected from, for example, samarium cobalt, neodynium-iron-boron, aluminum-nickel-cobalt, iron, iron oxide, cobalt, misch metal, ceramic magnets comprising barium ferrite and/or strontium ferrite, and mixtures thereof.

In one embodiment, the magnetic material comprises at least one paramagnetic material selected from, for example, aluminum, steel, copper, manganese, and mixtures thereof.

In one embodiment, the magnetic material comprises at least one ferromagnetic or ferrimagnetic or anti-ferromagnetic material selected from, for example, gadolinium, chromium, nickel, and iron, and mixtures thereof.

In one embodiment, a mixture of permanent magnetic materials (ferromagnetic and/or ferromagnetic) and paramagnetic materials is used.

In one embodiment, the magnetic material comprises at least one ferromagnetic or ferromagnetic material selected from, for example, iron oxides, such as Fe₃O₄ and Fe₂O₃.

In one embodiment, the magnetic material comprises at least one ferromagnetic material selected from, for example, Ni—Fe alloys, iron, and combinations thereof.

In one embodiment, the magnetic material comprises at least one ferrimagnetic material selected from, for example, rare earth transition metals, ferrite, gadolinium, terbium, and dysprosium with at least one of Fe, Ni, Co, and a lanthanide and combinations thereof.

In one embodiment, the magnetic material comprises at least one superconducting composition comprising a suitable combination of, for example, niobium, titanium, yttrium barium copper oxide, thallium barium calcium copper oxide, and bismuth strontium calcium copper oxide.

In one embodiment, the magnetic material comprises at least one anti-ferromagnetic material selected from, for example, FeMn, IrMn, PtMn, PtPdMn, RuRhMn, and combinations thereof.

The magnetic material can comprise one or more compounds selected from, for example, Fe₃O₄, Fe₂O₃, NdFeB alloys, SmCo₅, Sm₂Co₁₇, Sm₂Co₇, La_{0.9} Sm_{0.1}Ni₂Co₃, Ti_{0.51}Zr_{0.49}V_{0.70}Ni_{1.18}Cr_{0.12}. The magnetic material can comprise one or more compounds selected from, for example, Fe₃O₄, NdFeB and SmCo₅.

The magnetic material can comprise, for example, magnetic particles. The magnetic particles can be, for example, uncoated. The magnetic particles can comprises, for example, a magnetic core and at least one protective coating. The protective coating can comprise, for example, at least one inert material.

Other than magnetic particles, the magnetic material can be in the form of any type of microstructure materials, such as magnetic wires and magnetic meshes. In general, the magnetic material should be a small permanent magnet that can be incorporated into the magnetic element described herein. They do not have to be particles. In some embodiments, the electromagnets is part of the magnetic element.

Suitable inert materials for coating the magnetic particles include, for example, materials that do not adversely interact with the environment in which the particles are used. Such coatings can be used, for instance, to render the magnetic particles inert to corrosive effects of solvents and electrolytes such as acids, bases, and oxidants and reductions. Examples of suitable inert materials include, for example, substituted and unsubstituted polystyrenes, silanes and combinations thereof. Also, glasses, siloxanes, and other silicon containing materials can provide inert coatings.

In a particular embodiment, the inert material comprises one or more silanes. The silane can be, for example, represented by —Si—(CH₂)ₙ₋₁CH₃. n can be, for example, 1-20, or 1-10 or 1-5, or 1-2, or about 1. In a particular embodiments of the present invention, the magnetic particles are silane-coated Fe₃O₄ or NdFeB.

Other suitable inert coating include polystyrene coatings, polystyrene over a silanes, and siloxanes.

The size of the magnetic particles are not particularly limited. The diameter of the magnetic particles can be, for example, 1 to 1000 microns, 1 to 100 microns, or 1 to 50 microns, or 1 to 20 microns, or 1 to 10 microns. In some embodiment, the magnetic particles have a diameter of at least 1 micron to sustain a permanent magnetic field. In some embodiment, the magnetic particles have a diameter of at least 0.5 micron to sustain a permanent magnetic field.

### Methods for Making

In some embodiments where the magnetic element comprises a substrate coated with a magnetic material, the magnetic element can be made by dispersing the magnetic material in a suspension, depositing the suspension onto the substrate, and drying the coated substrate.

The suspension can comprise, for example, at least one polymer binder. The suspension can comprise, for example, at least one ion exchange polymer. The suspension can comprise, for example, at least one Nafion® polymer or a sulfonic acid polymer or a carboxylic acid polymer derivatives thereof. The suspension can comprise, for example, octadecyltrimethylammonium bromide (TMODA) modified Nafion or other alkyl-ammonium modified Nafion or other ion-exchange polymer.

In an alternative embodiment, the magnets may be held against the surface with an externally applied magnetic field and there is no binder present. Because this is an adsorption process, the binder is not rigorously required.

In one embodiment, the coated substrate is prepared in the presence of an external magnetic field, and the magnetic material is magnetized to sustain that magnetic field. In another embodiment, the coated substrate is prepared in the absence of an external magnetic field, and the magnetic material only sustain a residual magnetic field. The magnetic material may be magnetized prior to incorporation into the substrate coated.

In some embodiments where the magnetic element comprises a mixture of the hydrogen absorbing material and the magnetic material, the electrode can be made by melting the hydrogen-absorbing material and adding the magnetic material having a higher melting point.

The magnetic element described herein can be further processed to form a metal-hydride element by, for example, (i) contacting the magnetic element with a hydrogen source, wherein the magnetic element comprises a metal-based hydrogen-absorbing material and a magnetic material; and (ii) applying an electrochemical potential to form a metal hydride electrode.

The magnetic element described herein can be further processed to form a metal-hydride element by, for example, contacting a magnetic element with a pressurized hydrogen gas, wherein the magnetic element comprises a metal-based hydrogen-absorbing material and a magnetic material.

In some embodiments, the metal hydride element comprises a substrate and a magnetic coating disposed on the substrate, wherein the substrate comprises the metal hydride, and wherein the magnetic coating comprises the magnetic material. In some embodiments the magnetic coating is above the metal hydride forming material. In other embodiments, the magnetic material is below the metal hydride forming material. In other embodiments, the metal hydride electrode comprises a mixture of the metal hydride and the magnetic material.

### Method of Using

The metal hydride element described herein can be used in various energy-related applications. For example, hydrogen can be desorbed from the metal hydride element. The hydrogen desorbed can be used to, for example, generate energy such as electricity. Moreover, hydrogen can be resorbed into the element to form metal hydride, so that the hydride absorbing material can be used in multiple cycles.

The device comprising the magnetic element described herein can be used in various energy-related applications. For example, hydrogen can be absorbed into the magnetic element. Optionally, to reduce desorption of the absorbed hydrogen, the magnetic element can be demagnetized. Moreover, the absorbed hydrogen can be desorbed to generate energy.

### Performance

Compared to a conventional hydrogen absorbing element comprising hydrogen absorbing material but no magnetic material, the magnetic element described herein comprising the magnetic material can function to decrease the overpotential for electrochemically absorbing hydrogen to form metal hydride. For example, the presence of the magnetic material can increase the absorption rate of hydrogen into the hydrogen-absorbing material for at least 10%, or at least 100%, or at least 10 times, or at least 50 times. Further, the presence of the magnetic material can increase the desorption rate of hydrogen from the metal hydride element for at least 10%, or at least 100%, or at least 10 times, or at least 50 times.

Further, the amount hydrogen adsorbed at a given potential for a given period of time can be enhanced by, for example, at least 10%, or at least 100%, or at least 10 times, or at least 50 times. Additionally, that amount hydrogen desorbed at a given potential for a given period of time can be enhanced by, for example, at least 10%, or at least 100%, or at least 10 times, or at least 50 times.

Finally, the rate of atom transfer in the magnetic element and the metal hydride element described herein can be enhanced by, for example, at least 10%, or at least 100%, or at least 10 times, or at least 50 times.

### Applications

The magnetic element and the metal hydride element described herein can be used in a wide range of applications, including hydrogen-storage devices, hydrogen generation—storage devices, fuel cells, and batteries.

The magnetic element and the metal hydride element described herein can be used as electrode in, for example, a fuel cell. The magnetic element and the metal hydride element can be used in, for example, a fuel cell comprising hydride as the fuel storage matrix and possible the anode of the fuel cell. The magnetic element and the metal hydride element can be used in, for example, a proton exchange membrane (PEM) fuel cell.

The magnetic element and the metal hydride element described herein can be used as electrode in, for example, a battery. The magnetic element and the metal hydride element can be used in, for example, a nickel metal hydride battery. The magnetic element and the metal hydride element can be used in, for example, a nickel metal hydride battery, wherein the magnetic element and/or the metal hydride element is the counter-electrode that faces the Ni(OH)₂/NiOOH electrode (i.e., the negative electrode).

The magnetic element and metal hydride element described herein is used in, for example, a hydrogen storage device for absorbing hydrogen from pressurized hydrogen gas.

In some embodiments, the magnetic element and metal hydride element described herein can be used to isolate H₂ out of a reformat fuel stream (see Grashoff et al., Platinum Metals Rev. 1983, 27(4), 157-169).

### Hydrogen/Palladium Systems

Electrochemistry of Hydrogen in Palladium Systems

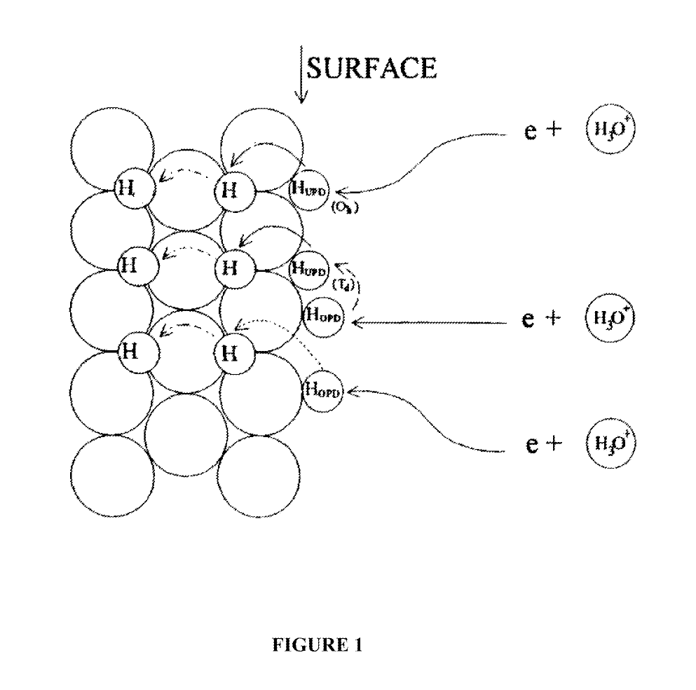

Palladium has an fcc structure with a lattice parameter of 0.3890 at 298K (Flanagan et al., Annu. Rev. Mater. Sci. 1991, 269-304). As hydrogen absorbs into the (111) face of the metal, the lattice undergoes an isotropic expansion while maintaining its fcc structure. A representation of the absorption of hydrogen into the palladium lattice is shown in FIG. 1. The absorbed hydrogen atoms can occupy both tetrahedral and octahedral sites within the lattice. For palladium, both underpotential deposited hydrogen (H_{UPD}) and overpotential deposited hydrogen (H_{OPD}) can occur within the same potential window (Jerkiewicz, Progress in Surface Science 1998, 57, 137-186).

A proposed mechanism for the formation of the metal hydride is:

M+H⁺+e→M−H_{ads} (2)

M−H_{ads}→M−H_{abs} (3)

where ads and abs indicate adsorbed as to the surface and absorbed as into the bulk.

This mechanism describes a kinetically driven system in which absorption of hydrogen and creation of the hydride is limited by the formation of the surface adsorbate. Consider the palladium electrode. H⁺ ions migrate to the surface of the electrode where an electron transfer occurs, yielding the adsorbed species. Note that the evolution of hydrogen gas at the electrode surface is not included in the mechanism as it is a side reaction not generated by the experiments herein. The kinetics of the absorption process are assumed to be relatively faster than the adsorption process, however, little is known about the actual kinetics of the reaction. The absorption process creates a metal hydride layer at the surface of the metal.

Cyclic Voltammetry

Cyclic voltammetry (CV) is an electrochemical technique in which current is measured as a potential range is scanned. CV provides unique information about the energetic costs of electroabsorbing hydrogen because the current output at the potential of absorption can be measured. To decrease energetic losses associated with electroabsorbing hydrogen, the increased current seen when hydrogen absorbs into the metal needs to occur at a lower potential than the potential for hydride formation in the absence of modification. The hydrogen absorption occurs on the forward sweep or the reductive wave of the voltammograms shown here.

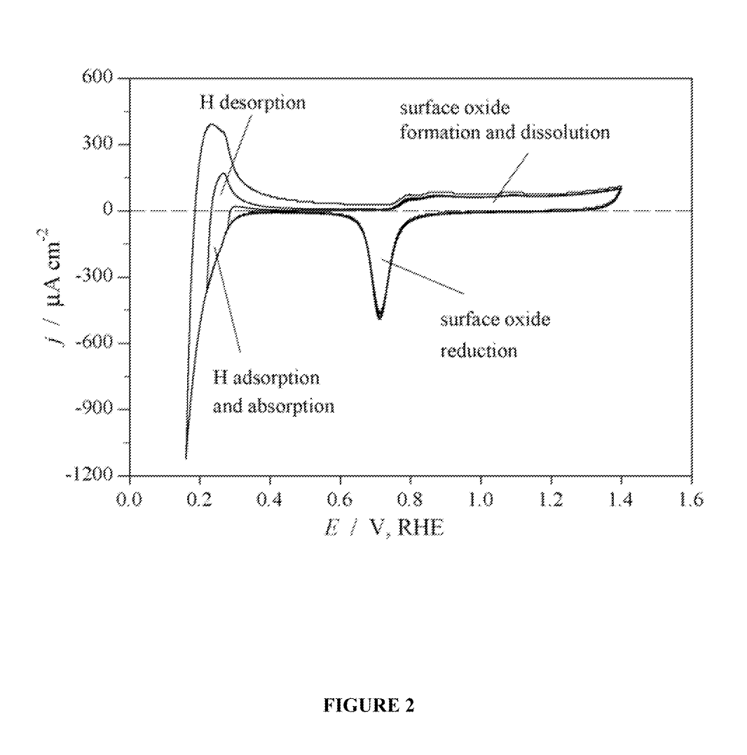

Grden et al. has done extensive electrochemical research on the palladium and hydrogen system (Grden et al., Electrochimica Acta 2008, 53, 7583-7598). FIG. 2 shows CV data obtained by Grden et al. for a bare palladium electrode in 0.5 M H₂SO₄ electrolyte at scan rate 50 mV/s. These data were used as a reference standard for the studies herein. In order to determine that the experimental observations obtained demonstrated the absorption phenomena expected, comparisons between experimental results and the reference voltammogram were made. Note that the reference electrode in Grden is RHE and in the following working examples the reference is SCE, which is V vs NHE. These comparisons can be found in the Example 3.

### WORKING EXAMPLES

### Example 1

### Electrodes and Instrumentation

The electrochemical cell is a three electrode cell. Measurements were made by cyclic voltammetry.

Working Electrode

The working electrode was a Pine Instruments palladium rotating disk electrode (RDE) with a Teflon shroud. All experiments were done on this one electrode. The electrode was of geometric area 0.438 cm². A detailed cleaning procedure was employed between uses to ensure electrode surface reproducibility. First, the electrode was cleaned with an ethanol soaked Kimwipe to dissolve any remaining polymer deposits. Next, the electrode was polished by hand on a polishing pad with, successively, 3, 1, 0.3, and 0.05 μm grit alumina oxide polishing powders (Buehler) in water slurry. The electrode was rinsed with water between different grits. Finally, the surface is rinsed thoroughly with distilled water and stored upright in a protective cylinder until ready for use.

Counter and Reference Electrodes

The counter electrode consisted of high surface area platinum mesh with a geometric area of approximately one inch squared. The electrode was cleaned by soaking in concentrated HNO₃ for five minutes and rinsed with distilled water prior to use. A saturated calomel electrode (SCE) with standard potential −0.2412 V vs. NHE served as the reference electrode. The SCE was cleaned by a brief rinse with distilled water prior to use and blotted dry with a Kimwipe.

Voltammetry

A CHI 1030 potentiostat from CH Instruments, Inc. was used to collect all cyclic voltammetric data. Voltammograms were typically recorded at various scan rates between 25 to 150 mV/s. The scans were taken with scan rate order randomized to eliminate scan rate bias and possible changes associated with extra electrochemical events. To be consistent with literature data, scans were commonly taken at a scan rate of 50 mV/s. The electrolyte and pH varied and are noted in each case. Common electrolytes were 0.1M NaNO₃ (Fisher) and 1.0 mM HNO₃ (Fisher). Electrolyte solutions were purged with nitrogen gas for 15 minutes before experimental tests. All experiments were conducted at room temperature. Voltammetric data were analyzed by macros created in Microsoft Excel.

### Example 2

### Magnetic Particles

Magnetic microparticles were obtained from several sources. The most effective microparticles were coated magnetite microparticles, SiMAG®, from commercial distributor Chemicell (Germany). The particles consist of a single core of magnetite (Fe₃O₄) encapsulated in a thin silane coat. The silane coat makes the magnetite chemically inert but is sufficiently thin to establish a magnetic field at the electrode surface. These particles have different chain length in the silane surface coatings and are named as Cₙ for —Si—(CH₂)ₙ₋₁CH₃ silane coatings. The names are listed in Table 1. The particles are identified by their short name throughout this section.

TABLE 1
Properties and naming of commercial Chemicell magnetite particles.

| Commercial Name | Functional Group Coating | Short Name |
|---|---|---|
| SiMAG-Methyl | —Si—CH₃ | C1 |
| SiMAG-Propyl | —Si—(CH₂)₂CH₃ | C3 |
| SiMAG-Octyl | —Si—(CH₂)₇CH₃ | C8 |
| SiMAG-Octadecyl | —Si—(CH₂)₁₇CH₃ | C18 |

Properties in common for the SiMAG particles regardless of silane chain length include average size of 1 μm, surface area of approximately 100 m²/g, and density of 2.25 g/cm³. Also, the number of particles is constant at 1.8×10¹²/g.

The magnetic susceptibility of the commercial SiMAG particles from Chemicell was previously determined in the same lab and summarized in Table 2. It is of note that the expected pattern of increasing chain length of coating decreasing the magnetic field strength is not consistently observed. The C18 particles have higher magnetic field strength measurements than C8 particles. Otherwise, the shorter chain lengths have stronger magnetic fields.

TABLE 2
Volume magnetic susceptibilities in centimeter-gram-second
units for SiMAG particles.

| | Volume magnetic susceptibility (c.g.s) |
|---|---|
| C1 | 5.39 × 10⁻⁵ |
| C3 | 2.39 × 10⁻⁵ |
| C8 | 8.60 × 10⁻⁶ |
| C18 | 1.96 × 10⁻⁵ |
| water | −1.06 × 10⁻⁶ |

Other microparticles included polymer magnetite composites from Bangs Laboratories, Inc. (ProMag PMC3N). These particles have an average size of 2.70 μm and density of approximately 1.22 g/cm³. Based on density, the magnetic content is less than the Chemicell particles.

### Example 3

### Nafion and Nafion Composite Modified Electrode

One of the ion exchange polymer coatings used in these experiments was Nafion®. Developed by scientists at DuPont, Nafion consists of a Teflon-like fluorocarbon backbone with side chains that terminate in sulfonic acid sites (Zook et al., J. Anal. Chem. 1996, 68, 3793-3796). The chemical structure of Nafion is:

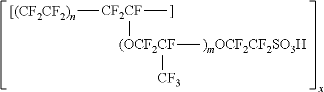

where m is usually 1; 5<=n<=7.

The proton from the sulfonic acid group can easily exchange cationic species from solution, including other protons from solution, such as HNO₃. Nafion, an ion conducting polymer, serves as a membrane film with high proton concentration between the electrode and electrolyte solution. Nafion is used to support micro-magnets on the electrode surface. Thus, simple Nafion films serve as controls for the magnetic composite films. Prior studies showed that Nafion films and Nafion films with low loading of polystyrene particles (<=5%) have the same cyclic voltammetric response (Minteer, S. D. Magnetic Field Effects on Electron Transfer Reactions, Ph.D. thesis, University of Iowa, 2000). In general, addition of nonmagnetic microparticles either yields the same cyclic voltammetric response as simple Nafion films or occasionally degrades performance relative to Nafion.

Preparation of Nafion and Composite Films

The Nafion films cast on the electrode are prepared from a commercial Nafion suspension (Ion Power, Inc.). The commercial suspension is 5% weight Nafion in a mixture of alcohols and water. The palladium working electrode is modified with either (a) a Nafion film; (b) a composite of Nafion and magnetic microparticles with no external magnetic field applied; or (c) a composite of Nafion and magnetic microparticles formed under an external magnetic field. All composites are 15% wt/wt magnetic particles.

The simple Nafion film preparation consists of depositing 5 μL of the Nafion suspension on the surface of the electrode via pipette.

For composite films, the Nafion suspension and microparticles are mixed in a centrifuge tube and then vortexed briefly to suspend microparticles. The suspension is used immediately to form composite modified electrodes. In composite cases, a 5 μL aliquot of Nafion and magnetic microparticles is applied to the electrode. When composites are aligned in the magnetic field, a NdFeB ring magnet encompassing the electrode surface is used. The ring magnet has outer diameter of 7.5 cm, inner diameter of 5 cm, and height of 1 cm. To magnetize the composite, the electrode modified by the suspension is centered inside a hollow cylinder and magnet. The field strength of the external magnet is sufficient to magnetize and align the microparticles. Once magnetized by an external field, the microparticles are able to sustain that magnetic field. Without magnetization by the external magnet, the microparticles may sustain a residual magnetic field. No attempt to demagnetize microparticles was made.

In all cases, the modified electrode was air dried in an upright position for 30 minutes before being placed in a vacuum desiccator to ensure complete evaporation of solvent. Vacuum drying times varied for composite and Nafion films. Interactions between the magnetic particles and the Nafion shorten the useable lifetime of the composite if the film is dried too long. Composite films are dried for 50 minutes whereas simple Nafion films are dried for upwards of 2 hours.

### Example 4

### TMODA and TMODA Composite Modified Electrode

A modified Nafion suspension, octadecyltrimethylammonium bromide (TMODA, Sigma) Nafion, was employed as a less harsh alternative to pure Nafion.

TMODA Chemistry and Preparation

The TMODA solution was prepared in the laboratory following the procedure outlined by Klotzbach et al., Membrane Sci. 2006, 276-283. TMODA Nafion is formed by exchanging the proton of Nafion with the TMODA cation. The TMODA modified Nafion has a lower ion exchange capacity because the film volume increases and is less acidic than a pure Nafion film. The milder environment is less likely to dissolve the magnetic microparticles and their coatings than the highly acidic proton exchanged Nafion.

Preparation of TMODA and Composite Films

The TMODA films cast on the electrode are prepared from TMODA modified Nafion. Prior to use, the suspension is vortexed approximately 15 seconds to ensure effective mixing of the Nafion and TMODA. The palladium working electrode was modified with either (a) a TMODA film; (b) a composite of TMODA and magnetic microparticles with no external magnetic field applied; (c) a composite of TMODA and magnetic microparticles formed under an external magnetic field; or (d) a composite of TMODA and 3 to 10 μm glass beads with density 2.5 g/cm³ (Polysciences, Inc.).

The simple TMODA film was prepared by depositing 5 μL of the TMODA suspension on the surface of the electrode with a pipette.

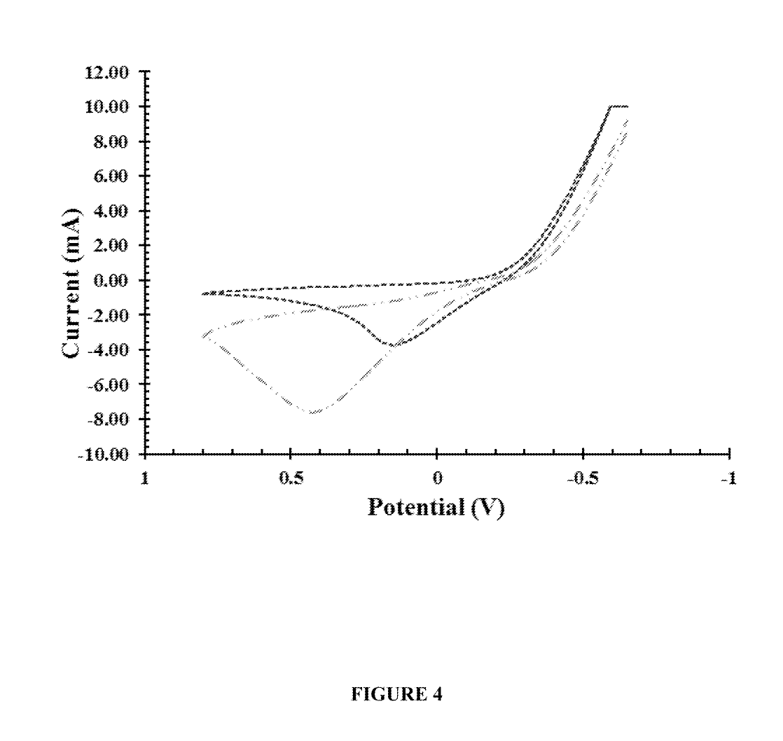

For composite films, a 5 μL aliquot of TMODA and magnetic microparticles is applied to the electrode The composite mixture was 50 mg microparticles per mL suspension. The composite suspensions were vortexed briefly to suspend microparticles prior to use and were refrigerated when not in use. A NdFeB ring magnet was used for magnetic field alignment (FIG. 4).

In each case, the modified electrode was air dried in an upright position for 30 minutes prior to being placed in a vacuum desiccator. All TMODA films were dried in a vacuum desiccator for 50 minutes.

The density of TMODA is not readily determined and varies with preparation of each new batch of TMODA modified Nafion, thus film thicknesses for TMODA and composite films are unknown. It is assumed that thicknesses are comparable to those of the Nafion films.

### Example 5

### Nafion Results

Comparison to Literature Studies

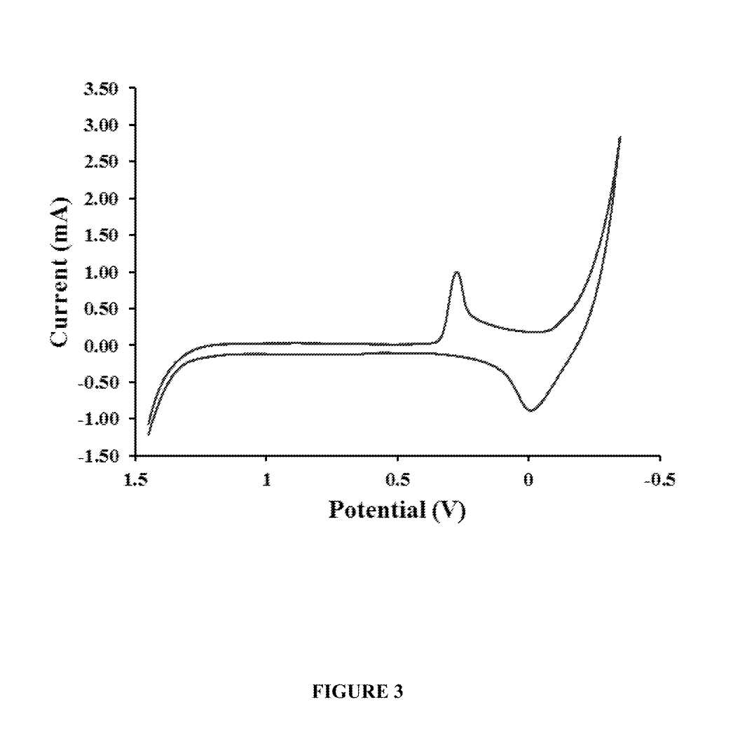

In order to verify the response seen from the reductive wave as actual hydrogen absorption, the unmodified palladium electrode was tested in acidic solution. FIG. 3 shows a voltammetric profile for the bare, unmodified Pd electrode in 0.1 M HNO₃ at scan rate of 50 mV/s.

The results seen on the bare electrode are similar to that of the bare electrode in sulfuric acid as witnessed by Jerkiewicz, Progress in Surface Science 1998, 57, 137-186. The reductive wave in shows a reduction of surface oxides followed by steep take off of the hydride absorption. The oxidative wave shows a large peak around 0 V corresponding to the desorption of hydrogen.

Composite Films of Nafion and Magnetic Particles

Initial tests of composite Nafion films were done with Bangs PMC3N magnetic microparticles. The composite film was dried within the field of a NdFeB ring magnet. An overlay of voltammetric data comparing the Nafion film with the composite can be seen in FIG. 4. The magnetic particles show enhanced current output at lower overpotential during the absorption process. It is unclear as to why the desorptive wave is so much larger for the blank Nafion film than for the composite. The acidity of Nafion does not appear to be ideal for the polymer coated Bangs microparticles, thus they were not used in further experiments.

### Example 6

### TMODA Results

The following details the results of the composite films made with TMODA.

SiMAG Particles

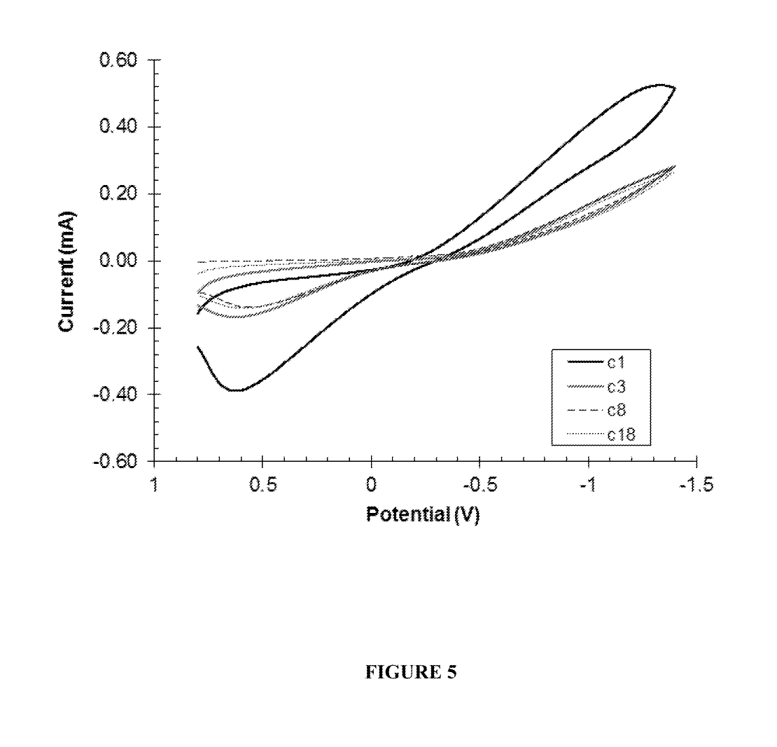

The SiMAG particles were the only magnetic microparticles used in composites with TMODA-Nafion because of their strong field strength and acid resistant silane coating. FIG. 5 displays the cyclic voltammogram overlay of the SiMAG particles and TMODA-Nafion composite in 1.0 mM HNO₃ electrolyte with scan rate of 50 mV/s. It is apparent that the C1 particles show greater current gains compared to the other SiMAG particles. This is likely due to the short silane chain length of the particle coating. Therefore, C1 particles were the choice magnetic particles for remaining trials.

TABLE 3
Current output based on magnetic particle type in the film
at −1.0 V potential during the reductive scan.

| SiMAG Particle in Film | Current (mA) at −1.0 V |
|---|---|
| C1 | 0.4065 |
| C3 | 0.1682 |
| C8 | 0 1683 |
| C18 | 0.1583 |

The current output based on SiMAG particle type in the composite at −1.0 V potential during hydrogen absorption is shown in Table 3. At this arbitrary potential it is clear that C1 magnetic microparticles outperform the other SiMAG magnetic particles by nearly three times the current output.

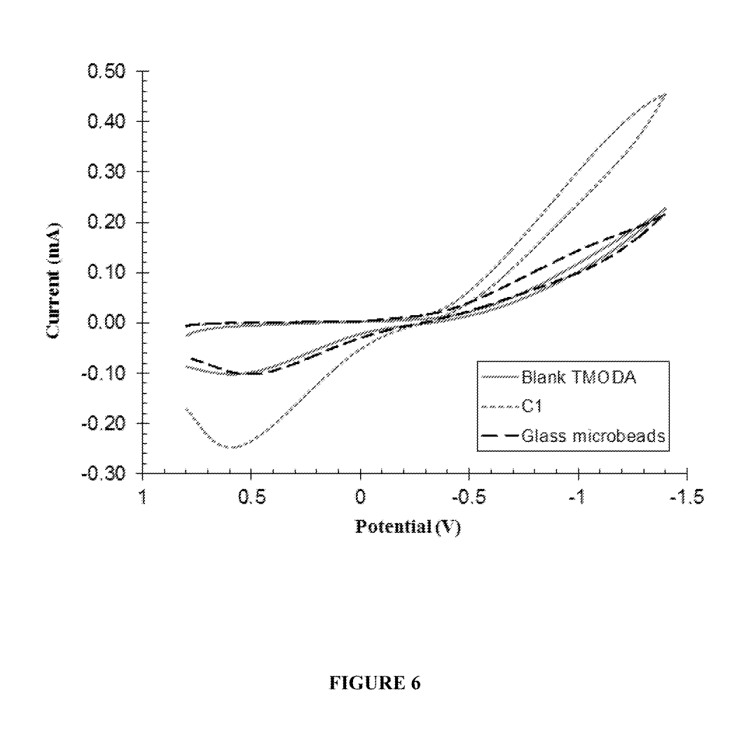

To confirm that the effect of increased current at a lesser potential was due exclusively to the magnetic property of the particles, and not general particulate matter effects in the film, a composite film of TMODA-Nafion containing glass microbeads was cast and tested in 1.0 mM HNO₃ electrolyte. FIG. 6 shows an overlay of the CV data obtained for a blank TMODA-Nafion film, a composite of TMODA-Nafion and C1, and a composite of TMODA and glass microbeads. The glass microbeads showed similar performance to that of the blank thus confirming that the increased current observed is due solely to the presence of the magnetic microparticles and not to general particulate species.

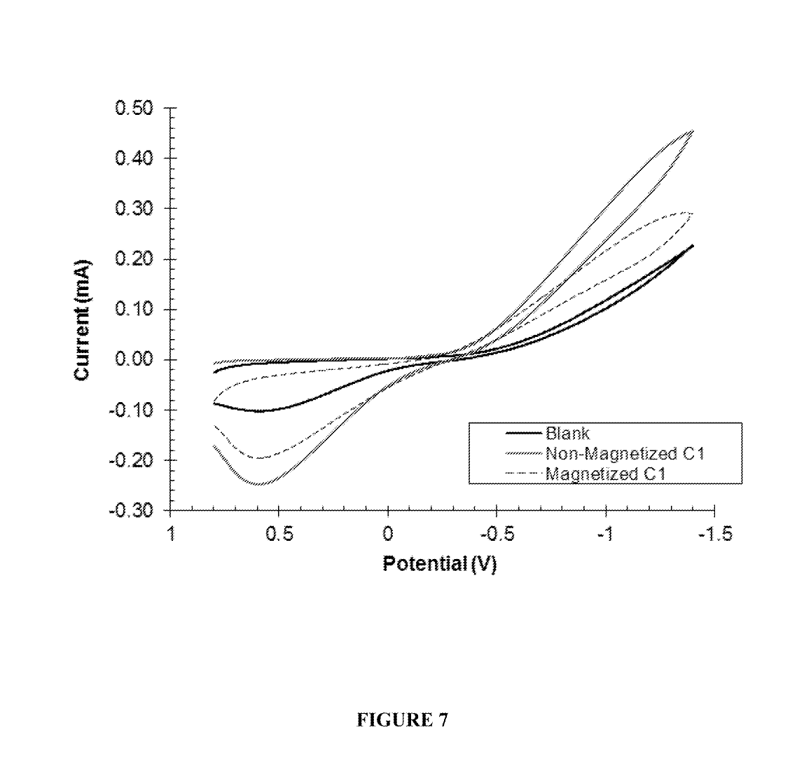

The question arose as to whether field alignment of the magnetic microparticles had any influence on current gains. FIG. 7 displays an overlay of cyclic voltammograms of blank TMODA, and composites containing C1 microparticles that are either magnetized or nonmagnetized. The magnetized composite film was exposed to an external magnetic field while drying. It is found that the non-magnetized composite outperforms the magnetized version. Table 4 displays data describing the current output at −1.0 V on the reductive wave. The nonmagnetized C1 particles outperform the magnetized C1 particles with approximately 1.5 times more current at the same overpotential. The composite films both outperform the blank TMODA-Nafion film, but the nonmagnetized C1 particles provide 2.7 times more current output than the blank, whereas the magnetized C1 particles provide 1.8 times more current. This raises the question as to why not externally magnetizing the microparticles shows greater current gains than the magnetized particles. This is likely due to a better distribution of the magnetic field on the surface of the electrode in the nonmagnetized case where the particles have a residual magnetic field. Placing the electrode in an external magnetic field to magnetize the microparticles causes the particles to align and form pylons on the electrode surface. This causes a less well distributed magnetic field on the electrode surface with less magnetic particles immediately at the electrode surface.

TABLE 4
Current output based on film composition at −1.0 V potential
during the reductive scan.

| Film Composition | Current (mA) at −1.0 V |
|---|---|
| Blank TMODA | 0.118 |
| Magnetized C1 particles in TMODA | 0.216 |
| Non-magnetized C1 particles in TMODA | 0.321 |

pH Effects

The effect of pH was studied in order to determine how the system responds to changes in the concentration of H⁺ in solution.

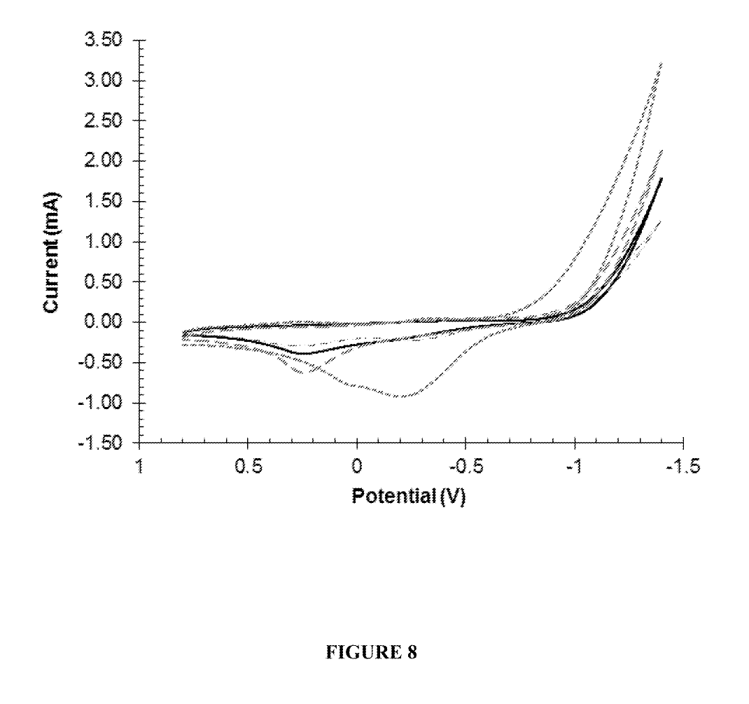

The location of the hydride desorption peak was not well defined in supporting literature, causing uncertainty about the large broad peak occurring on the oxidative wave. To verify that this peak is that of hydride desorption, the C1 and TMODA composite film was tested in 1.0 M NaNO₃ electrolyte at pH 5.16 and pH 10.01. NaOH was added to the electrolyte solution to achieve pH 10.01. An increase in pH caused a decrease in the oxidative wave, indicative of lower H′ ion concentration rather than an oxide stripping wave. The TMODA-Nafion film was also tested in the 1.0 mM NaNO₃ electrolyte at pH 10. FIG. 8 shows an overlay of the CV data collected at pH 5 and pH 10.

Examination of FIG. 8 revealed that the blank TMODA-Nafion electrode in pH 5 electrolyte performed similarly to the composite film in pH 10. Thus, it took five orders of magnitude decrease in the concentration of H⁺ for the magnetic microparticles to give current output comparable to an electrode without magnets. The absorption take-off peak in the reductive scan for C1 at pH 5 occurs several hundred millivolts before that of the blank films. The blank TMODA film modified electrodes can be thought of as the traditional palladium hydride system. Therefore, by adding magnetic microparticles to the traditional palladium hydride system, the overpotential required to electrochemically absorb hydrogen is decreased.

Table 5 displays the current output for the blank films and composite films at pH values of 5 and 10. The blank TMODA films perform similarly regardless of H⁺ concentration. The magnetic C1 microparticles give nearly twice as much current output as the blank film in pH 5 solution, thus indicating that the magnetic particles are inducing the increased current output. This means that the absorption rate of hydrogen into the metal is increased by adding magnetic microparticles to the surface of the electrode.

TABLE 5
Current output based on film composition and pH of electrolyte
at −1.0 V potential during the reductive scan.

| Film Composition | Current (mA) at −1.0 V |
|---|---|
| Blank TMODA, pH 5 | 0.110 |
| Blank TMODA, pH 10 | 0.082 |
| C1 particles in TMODA, pH 5 | 0.193 |
| C1 particles in TMODA, pH 10 | 0.194 |

What is claimed is:

1. A device comprising a magnetic element, which comprises a magnetic material, wherein the magnetic element is adapted to absorb hydrogen to form hydride.

2. The device of claim 1, wherein the magnetic element comprises a hydrogen-absorbing material different from the magnetic material.

3. The device of claim 1, wherein the magnetic material is a hydrogen-absorbing material.

4. The device of claim 1, wherein the magnetic element comprises a substrate and a coating disposed on the substrate, wherein:
(i) the substrate comprises a hydrogen-absorbing material different from the magnetic material, and wherein the coating comprises the magnetic material, or
(ii) the substrate comprises the magnetic material, and wherein the coating comprises a hydrogen-absorbing material different from the magnetic material.

5. The device of claim 1, wherein the magnetic element comprises a mixture of the magnetic material and a hydrogen-absorbing material different from the magnetic material.

6. The device of claim 1, wherein the magnetic element comprises metal for hydrogen absorption.

7. The device of claim 1, wherein the magnetic element comprises Pd or an alloy thereof.

8. The device of claim 1, wherein the magnetic element comprises an AB₂ or AB_{S} material.

9. The device of claim 1, wherein the magnetic material comprises Fe₃O₄, Fe₂O₃, NdFeB, SmCo₅, Sm₂Co₁₇, Sm₂Co₇, La_{0.9}Sm_{0.1}Ni₂Co₃, Ti_{0.51}Zr_{0.49}V_{0.70}Ni_{1.18}Cr_{0.12}, or a combination thereof.

10. The device of claim 1, wherein the magnetic material comprises Fe₃O₄, NdFeB, SmCo₅, or a combination thereof.

11. The device of claim 1, wherein the magnetic material comprises at least one magnetic particle, magnetic wire, or magnetic mesh.

12. The device of claim 1, wherein the magnetic material comprises at least one magnetic particle comprising a magnetic core and a protective coating.

13. The device of claim 1, wherein the magnetic material comprises at least one magnetic particle comprising a magnetic core and a silane protective coating.

14. The device of claim 1, wherein the magnetic material comprises at least one magnetic particle comprising a Fe₃O₄ magnetic core and a —Si—CH₃ protective coating.

15. The device of claim 1, wherein the magnetic material is not externally magnetized.

16. The device of claim 1, wherein the magnetic material is externally magnetized.

17. The device of claim 4, wherein the magnetic coating further comprises at least one polymer.

18. The device of claim 4, wherein the magnetic coating further comprises at least one ion exchange polymer or at least one conducting polymer.

19. The device of claim 4, wherein the magnetic coating further comprises at least one Nafion polymer or derivative thereof.

20. The device of claim 4, wherein the magnetic coating further comprises octadecyltrimethylammonium bromide Nafion or an alkyl ammonium modified Nafion.

21. The device of claim 1, wherein the magnetic element comprises metal, and wherein the presence of the magnetic material decreases the potential or energy tax/cost for electrochemically absorbing hydrogen to form metal hydride.

22. The device of claim 1, wherein the magnetic material increases the absorption rate of hydrogen into the magnetic element by at least 10%, or wherein the magnetic material increases the desorption rate of hydrogen into the magnetic element by at least 10%.

23. The device of claim 1, wherein the magnetic element is an electrode.

24. The device of claim 1, wherein the magnetic element comprises metal hydride.

25. The device of claim 1, wherein the device is a fuel cell.

26. A metal hydride element comprising a magnetic material.

27. The metal hydride element of claim 26, wherein the metal hydride element comprises a substrate and a coating disposed on the substrate, wherein:
(i) the substrate comprises a metal hydride different from the magnetic material, and wherein the coating comprises the magnetic material, or
(ii) the substrate comprises the magnetic material, and wherein the coating comprises a metal hydride different from the magnetic material.

28. The metal hydride element of claim 26, wherein the metal hydride element comprises a mixture of the magnetic material and a metal hydride different from the magnetic material.

29. The metal hydride element of claim 26, wherein the magnetic material comprises metal hydride.

30. The metal hydride element of claim 26, wherein the metal hydride element comprises Pd, an alloy thereof, or an AB₂ or AB_{S} material.

31. The metal hydride element of claim 26, wherein the magnetic material comprises at least one magnetic particle, magnetic wire, or magnetic mesh.

32. The metal hydride element of claim 26, wherein the magnetic material comprises Fe₃O₄, Fe₂O₃, NdFeB, SmCo₅, Sm₂Co₁₇, Sm₂Co₇, La_{0.9} Sm_{0.1}Ni₂Co₃, Ti_{0.51}Zr_{0.49}V_{0.70}Ni_{1.18}Cr_{0.12}, or a combination thereof.

33. The metal hydride element of claim 26, wherein the presence of the magnetic material decreases the overpotential for electrochemically absorbing hydrogen to form metal hydride.

34. The metal hydride element of claim 26, wherein the metal hydride element is substantially free of any metal hydroxide.

35. A fuel cell device comprising the metal hydride element of claim 26 as electrode.

36. A nickel metal hydride battery comprising the metal hydride element of claim 26 as electrode.

37. A method for making the metal hydride element of claim 26, comprising (i) contacting a magnetic element with a hydrogen source, wherein the magnetic element comprises a metal-based hydrogen-absorbing material and a magnetic material; and (ii) applying an electrochemical potential to form a metal hydride element.

38. A method for making the metal hydride element of claim 26, comprising contacting a magnetic element with a pressurized hydrogen gas, wherein the magnetic element comprises a metal-based hydrogen-absorbing material and a magnetic material.

39. A method for using the device of claim 1, comprising absorbing hydrogen into the magnetic element, and optionally desorbing hydrogen therefrom.

40. The method of claim 39, further comprising demagnetizing the magnetic material to reduce desorption of the absorbed hydrogen.

41. A method for using the metal hydride element of claim 26, comprising desorbing hydrogen from the metal hydride element, and optionally resorbing hydrogen to form metal hydride.

42. The method of claim 41, further comprising using the desorbed hydrogen to generate energy.
